(19) United States
(12) Patent Application Publication
(10) Pub. No.: US 2025/0202634 A1
(43) Pub. Date: Jun. 19, 2025

(54) APPARATUS AND METHOD FOR SUBBAND TIME-FREQUENCY CONFIGURATION

(71) Applicant: Lenovo (Singapore) Pte. Ltd., Singapore (SG)

(72) Inventor: Khaled Nafez Rauf Ardah, Ilmenau (DE)

(21) Appl. No.: 18/979,000

(22) Filed: Dec. 12, 2024

Related U.S. Application Data
(60) Provisional application No. 63/609,586, filed on Dec. 13, 2023.

(51) Int. Cl. H04L 5/00; H04L 5/14; H04W 72/0446

(52) U.S. Cl. CPC H04L 5/0005; H04L 5/14; H04W 72/0446

(57) ABSTRACT

Various aspects of the present disclosure relate to: receiving a configuration message for a subband time-frequency configuration, wherein the configuration message indicates frequency domain resources and time domain resources of at least one subband; and determining a transmission direction of the at least one subband, wherein the transmission direction comprises downlink, uplink, guard-band, or a combination thereof.

### TECHNICAL FIELD

The present disclosure relates to wireless communications, and more specifically to transmitting subband (SB) time-frequency configuration in a wireless network.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

Some implementations of the method and apparatuses described herein may further include: receiving a configuration message for a subband time-frequency configuration, wherein the configuration message indicates frequency domain resources and time domain resources of at least one subband; and determining a transmission direction of the at least one subband, wherein the transmission direction comprises downlink, uplink, guard-band, or a combination thereof.

### BRIEF DESCRIPTION OF THE DRAWINGS

FIG. 1 illustrates an example of a wireless communications system in accordance with aspects of the present disclosure.

FIG. 2 illustrates an example of a tdd-UL-DL-ConfigurationCommon and a tdd-UL-DL-ConfigurationDedicated.

FIG. 3 illustrates an example of time division duplex (TDD) and subband full duplex (SBFD).

FIG. 4 illustrates examples of SBFD slot frequency domain subband (SB) configurations.

FIG. 5 illustrates an example in which nrofRBs is indicated as percentage of the SB resource blocks (RBs) as compared to the total number of RBs N_{RBs}.

FIG. 6 illustrates an example of a slot specific X slots indication.

FIG. 7 illustrates an example of an X slots indication as a number of X slots or X symbols.

FIG. 8 illustrates an example of an X slots and/or symbols indication as a number of X slots and/or symbols and s starting and/or first X slot and/or symbol.

FIG. 9 illustrates an example of a one-to-one mapping between a SBFD TDD uplink-downlink (UL-DL) pattern and a TDD UL-DL pattern.

FIG. 10 illustrates a first example of a one-to-many mapping between a SBFD UL-DL pattern and two TDD UL-DL patterns.

FIG. 11 illustrates a second example of a one-to-many mapping between a SBFD UL-DL pattern and two TDD UL-DL patterns.

FIG. 12 illustrates an example of a UE in accordance with aspects of the present disclosure.

FIG. 13 illustrates an example of a processor in accordance with aspects of the present disclosure.

FIG. 14 illustrates an example of a network equipment (NE) in accordance with aspects of the present disclosure.

FIG. 15 illustrates a flowchart of a method performed by a UE in accordance with aspects of the present disclosure.

FIG. 16 illustrates a flowchart of a method performed by a NE in accordance with aspects of the present disclosure.

### DETAILED DESCRIPTION

Various aspects of the present disclosure relate to a system that supports SB time-frequency configuration. The SB time-time configurations found herein may be used to indicate time resources and frequency resources for SBFD communications.

Aspects of the present disclosure are described in the context of a wireless communications system.

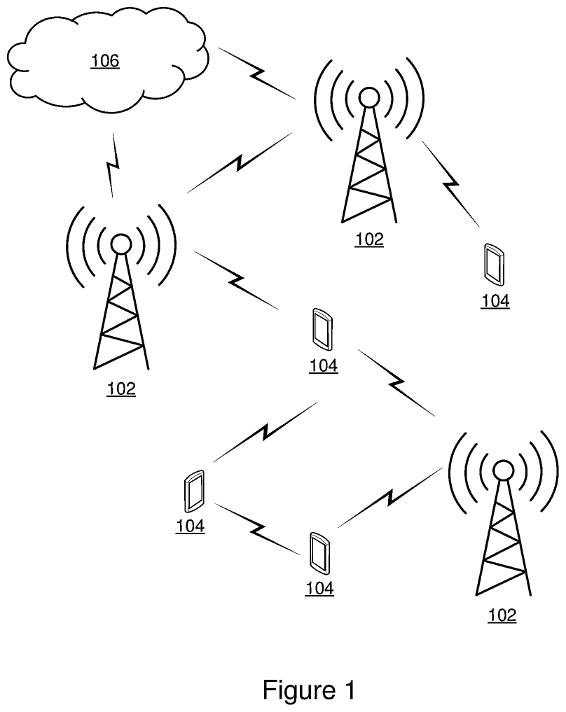

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a new radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a UE-to-UE interface (PC5 interface).

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., orthogonal frequency division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHZ-24.25 GHz), FR4 (52.6 GHz-114.25 GHz), FR4a or FR4-1 (52.6 GHz-71 GHZ), and FR5 (114.25 GHZ-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

In some configurations, TDD is widely used in commercial NR deployments, which splits time resources (e.g., symbols and slots) between downlink (DL) and uplink (UL) communications. However, the limited allocation of time resources for UL communications in TDD may result in reduced UL coverage, reduced UL capacity, and/or increased UL latency.

As a possible enhancement to TDD-based systems, a duplexing scheme called non-overlapping SBFD may enable simultaneous existence of DL and UL communications at the same time by splitting frequency resources of a time symbol and/or slot into non-overlapping DL and UL subbands, wherein each subband includes one or more of resource-blocks (RBs).

In various configurations, TDD UL and/or DL configuration messages classify only time domain resources into DL symbols and/or slots, UL symbols and/or slots, or flexible symbols and/or slots, but do not classify the frequency resources of a time symbol and/or slot into non-overlapping DL and UL subbands.

In certain configurations, a slot format includes downlink symbols, uplink symbols, and flexible symbols. Moreover, the following may be applicable for each serving cell. If a UE is provided tdd-UL-DL-ConfigurationCommon, the UE sets the slot format per slot over a number of slots as indicated by tdd-UL-DL-ConfigurationCommon.

The tdd-UL-DL-ConfigurationCommon may provide: 1) a reference subcarrier spacing (SCS) configuration μ_{ref} by referenceSubcarrierSpacing; and/or 2) a pattern1.

Moreover, the pattern1 may provide: 1) a slot configuration period of P msec by dl-UL-TransmissionPeriodicity; 2) a number of slots a slots dₛₗₒₜₛ with only downlink symbols by nrofDownlinkSlots; 3) a number of downlink symbols d_{sym} by nrofDownlinkSymbols; 4) a number of slots μₛₗₒₜₛ with only uplink symbols by nrofUplinkSlots; and/or 5) a number of uplink symbols μ_{sym} by nrofUplinkSymbols.

In some configurations, a value P=0.625 msec is valid only for μ_{ref}=3, μ_{ref}=5 or μ_{ref}=6; a value P=1.25 msec is valid only for μ_{ref}=2, μ_{ref}=3, μ_{ref}=5 or μ_{ref}=6; a value P=2.5 msec is valid only for μ_{ref}=1, μ_{ref}=2, μ_{ref}=3, μ_{ref}=5 or μ_{ref}=6; and a value P=10 msec is valid only for μ_{ref}=0, μ_{ref}=1, μ_{ref}=2, μ_{ref}=3 or μ_{ref}=5.

In various configurations, a slot configuration period of P msec includes S=P·2^{μ}^{_{ref}} slots with SCS configuration μ_{ref}. From the S slots, a first a dₛₗₒₜₛ slots include only downlink symbols and a last μₛₗₒₜₛ slots include only uplink symbols. The d_{sym} symbols after the first dₛₗₒₜₛ slots are downlink symbols. The μ_{sym} symbols before the last μₛₗₒₜₛ slots are uplink symbols. The remaining (S−dₛₗₒₜₛ−μₛₗₒₜₛ)·N_{symb}^{slot}−d_{sym}−μ_{sym} are flexible symbols. The first symbol every 20/P periods is a first symbol in an even frame.

If tdd-UL-DL-ConfigurationCommon provides both pattern1 and pattern2, the UE sets the slot format per slot over a first number of slots as indicated by pattern1 and the UE sets the slot format per slot over a second number of slots as indicated by pattern2.

In certain configurations, the pattern2 may provide: 1) a slot configuration period of P₂ msec by dl-UL-TransmissionPeriodicity; 2) a number of slots d_{slots,2} with only downlink symbols by nrofDownlinkSlots; 3) a number of downlink symbols d_{sym,2} by nrofDownlinkSymbols; 4) a number of slots μ_{slots,2} with only uplink symbols by nrofUplinkSlots; and/or 5) a number of uplink symbols μ_{sym,2} by nrofUplinkSymbols.

The applicable values of P₂ are same as the applicable values for P. A slot configuration period of P+P₂ msec includes first S=P·2^{μ}^{_{ref}} slots and second S₂=P₂·2^{μ}^{_{ref}} slots. From the S₂ slots, a first d_{slots,2} slots include only downlink symbols and a last μ_{slots,2} include only uplink symbols. The d_{sym,2} symbols after the first d_{slots,2} slots are downlink symbols. The μ_{sym,2} symbols before the last μ_{slots,2} slots are uplink symbols. The remaining (S₂−d_{slots,2}−μ_{slots,2})·N_{symb}^{slot}−d_{sym,2}−μ_{sym,2} are flexible symbols. A UE expects that P+P₂ divides 20 msec. The first symbol every 20/(P+P₂) periods is a first symbol in an even frame.

In some configurations, a UE expects that the reference SCS configuration μ_{ref} is smaller than or equal to a SCS configuration μ for any configured DL bandwidth part (BWP) or UL BWP. Each slot provided by pattern1 or pattern2 is applicable to 2^{(μ-μ}^{_{ref}}⁾ consecutive slots in the active DL BWP or the active UL BWP where the first slot starts at a same time as a first slot for the reference SCS configuration μ_{ref} and each downlink or flexible or uplink symbol for the reference SCS configuration μ_{ref} corresponds to 2^{(μ-μ}^{_{ref}}⁾ consecutive downlink or flexible or uplink symbols for the SCS configuration μ.

If the UE is additionally provided tdd-UL-DL-ConfigurationDedicated, the parameter tdd-UL-DL-ConfigurationDedicated overrides only flexible symbols per slot over the number of slots as provided by tdd-UL-DL-ConfigurationCommon.

In various configurations, the tdd-UL-DL-ConfigurationDedicated may provide a set of slot configurations by slotSpecificConfigurationsToAddModList. For each slot configuration from the set of slot configurations, the following are provided: 1) a slot index for a slot provided by slotindex; 2) a set of symbols for a slot by symbols where, a) if symbols=allDownlink, all symbols in the slot are downlink, b) if symbols=allUplink, all symbols in the slot are uplink, and c) if symbols=explicit, nrofDownlinkSymbols provides a number of downlink first symbols in the slot and nrofUplinkSymbols provides a number of uplink last symbols in the slot. If nrofDownlinkSymbols is not provided, there are no downlink first symbols in the slot and if nrofUplinkSymbols is not provided, there are no uplink last symbols in the slot. The remaining symbols in the slot are flexible.

For each slot having a corresponding index provided by slotIndex, the UE applies a format provided by a corresponding symbols. The UE does not expect tdd-UL-DL-ConfigurationDedicated to indicate as uplink or as downlink a symbol that tdd-UL-DL-ConfigurationCommon indicates as a downlink or as an uplink symbol, respectively.

For a set of symbols of a slot that are indicated to a UE as downlink by tdd-UL-DL-ConfigurationCommon, or tdd-UL-DL-ConfigurationDedicated, the UE does not transmit physical uplink shared channel (PUSCH), physical uplink control channel (PUCCH), physical random access channel (PRACH), or SRS when the PUSCH, PUCCH, PRACH, or SRS overlaps, even partially, with the set of symbols of the slot.

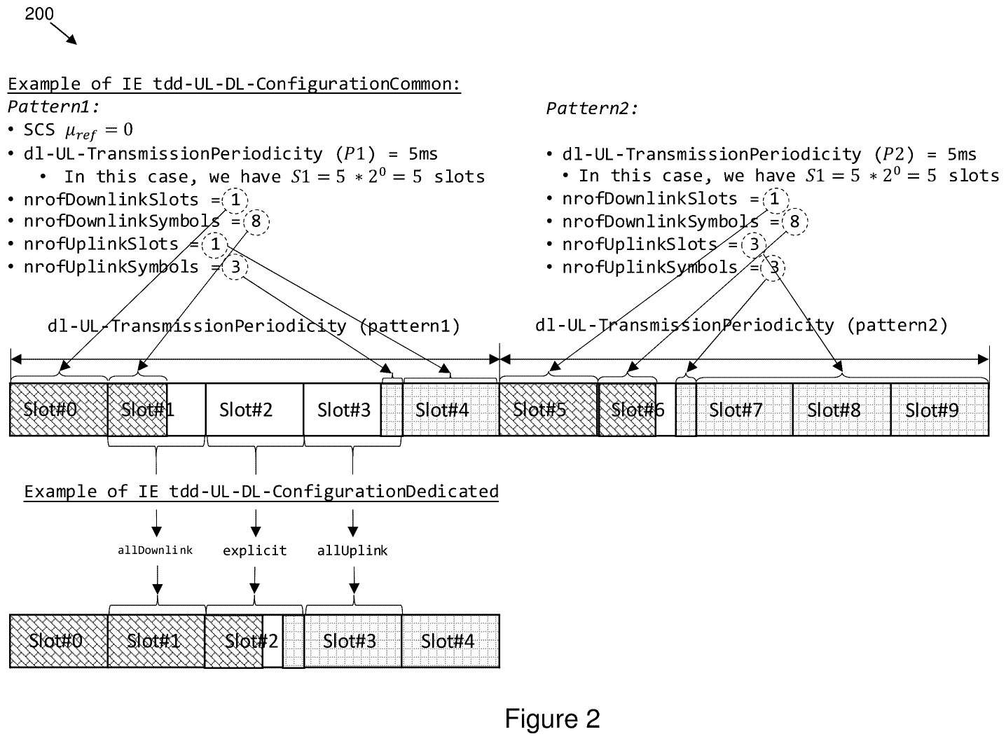

FIG. 2 illustrates an example 200 of a tdd-UL-DL-ConfigurationCommon and a tdd-UL-DL-ConfigurationDedicated.

A SBFD scheme may be used to overcome issues encountered by legacy TDD schemes (e.g., reduced UL coverage, reduced UL capacity, and increased UL latency) by splitting the frequency domain resources of one or more of DL and/or flexible (F) symbols and/or slots into non-overlapping DL and UL subbands and therefore increasing the allocated time and frequency resources of UL communications.

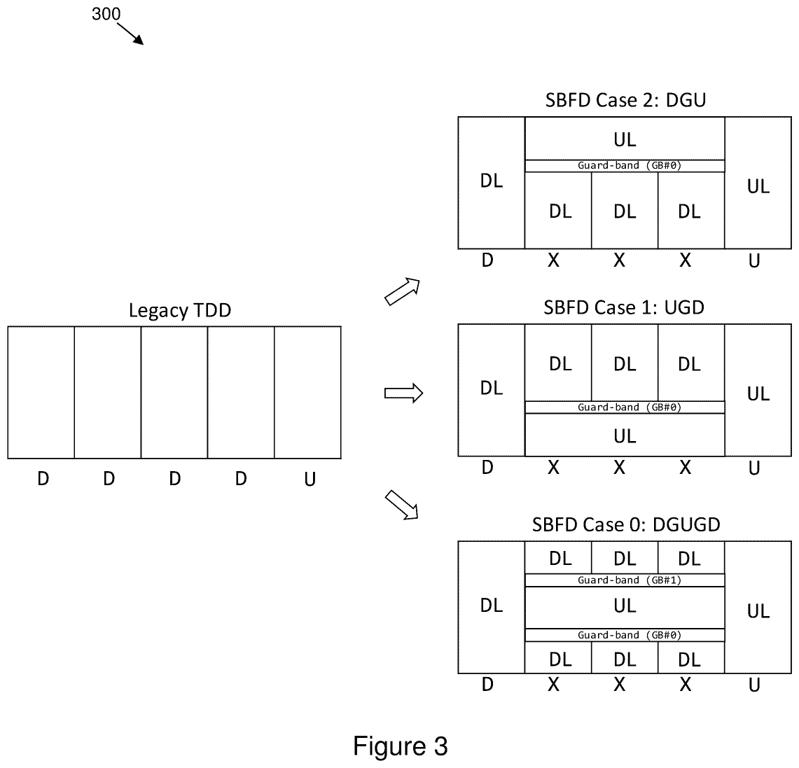

FIG. 3 illustrates an example 300 of TDD and SBFD. Specifically, FIG. 3 shows a reconfiguration example of a DDDDU legacy TDD slot configuration into three DXXXU SBFD slot configuration, where the frequency domain of X slots (e.g., SBFD slots) is divided into non-overlapping DL and UL subbands. SBFD-based configuration allocates more UL resources to UL communications as compared to legacy TDD, which can increase the UL communications capacity and coverage. Moreover, the UL frequency resources with SBFD-based configuration are available starting from a second slot (e.g., Slot #1 illustrated in FIG. 2) as opposed to legacy TDD-based configuration, wherein the UL frequency resources are only available at Slot #4 as illustrated in FIG. 2. This may help improve and/or reduce UL communications latency as compared to a legacy TDD-based configuration.

Moreover, FIG. 3 shows three different SBFD-based slots (e.g., X slot configuration examples) from which the scheduling network entity may choose from depending on various factors such as a deployment scenario and/or a UEs traffic needs. Other configuration examples exist and are not precluded.

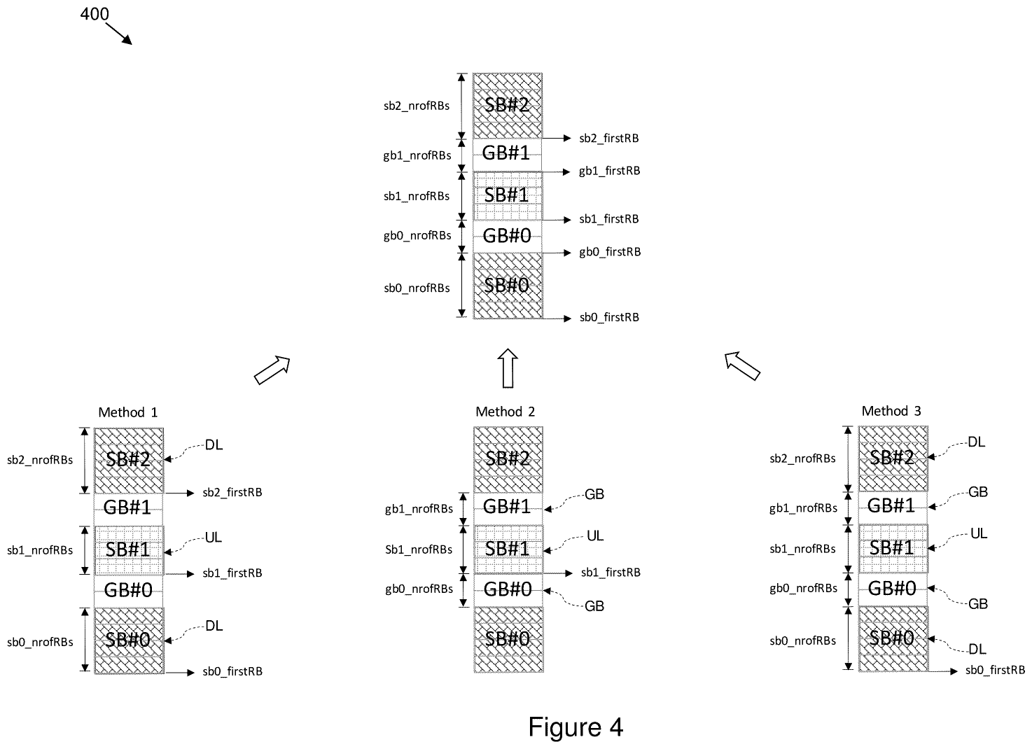

In SBFD-based configurations as shown in FIG. 3, every X slot includes one or two DL SBs, one UL SB, and one or two guard-band (GB) SBs, wherein each SB includes one or more of resource blocks (RBs). Current TDD slot configurations, e.g., tdd-UL-DL-ConfigurationCommon and tdd-UL-DL-ConfigurationDedicated, if configured, may classify only time domain slots, e.g., into DL, UL and F slots and/or symbols, but not the frequency domain resources. Regardless of the employed frequency domain SBs configuration method, every SB within an X slot and/or symbol may be categorized with three parameters (e.g., starting and/or first RB, length and/or number of RBs, and SB usage (e.g., DL SB, UL SB, or GB SB)) as illustrated in FIG. 4. However, not all SBs and/or SB configurations need to be indicated to a second network node (e.g., UE) for it to identify the frequency configuration of an X slot.

In a first embodiment, a first network node (e.g., a serving network node) indicates frequency domain SB configurations (e.g., firstRB, nrofRBs, and SB usage) of one or more SBs of one or more of an indicated X slot and/or symbol to a second network node (e.g., UE) using one or more of the methods illustrated in FIG. 4.

Specifically, FIG. 4 illustrates examples 400 of SBFD slot frequency domain SB configurations.

In method 1, the first network node indicates the SB configurations (e.g., firstRB, nrofRBs, and SB usage) of DL and UL SBs, wherein the UE assumes that the remaining RBs are GB SBs.

In method 2, the first network node indicates the SB configurations (e.g., firstRB, nrofRBs, and/or SB usage) of UL and GB SBs, wherein the UE assumes that the remaining RBs are DL SBs. In some implementations, the serving node indicates the full SB configurations of UL SB (e.g., firstRB, nrofRBs, and SB usage), while for GB SBs it is sufficient to indicate the nrofRBs, wherein the UE assumes that adjacent RB of the indicated UL SB is the firstRBs of GB SBs, and wherein the SB usage of UL SB is implicitly or explicitly indicated. In some other implementations, only the UL SB configurations are indicated, wherein the GB SBs are preconfigured.

In method 3, the first network node indicates the nrofRBs and SB usage of all SBs, wherein firstRB is only indicated for first SB. In some implementations, only the DL and UL SB configurations are indicated, wherein the GB SBs are preconfigured.

In various implementations, the SBs usage is indicated explicitly, as shown in FIG. 4. In some other implementations, the SBs usage is indicated implicitly (e.g., the indicated SB configurations are always for an UL SB). In some other implementations, the SBs usage is indicated by selecting an index of a predefined X slot SB configuration (e.g., as shown in Table 1. For example, DGU X slot SBs configuration implies that the frequency domain resources of an X slot are divided into three non-overlapping SBs as a DL SB (e.g., D), a guard-band (e.g., G), and an UL SB (e.g., U)).

TABLE 1
Predefined X slot SBs configurations

| Index | X slot SBs configurations |
|---|---|
| 0 | DGUGD |
| 1 | DGU |
| 2 | UGD |
| 3 | DUD |
| 4 | DU |
| 5 | UD |

In certain implementations, the serving network node indicates firstRB and nrofRBs of a SB separately (e.g., firstRB=105 and nrofRBs=55).

In some other implementations, the firstRB and nrofRBs of a SB are indicated in terms of RB groups (RBGs), where the grouping level is either fixed or indicated to the second network node. For example, if firstRB=105 and nrofRBs=55, the first network node indicates firstRBG=21, nrofRBGs=5, and the grouping level as 5.

In yet other implementations, the serving network node indicates firstRB (defined as RB_{first}) and nrofRBs (defined as L_{RBs}) of a SB, e.g., by mapping them to a resource indication value (RIV) that is defined as:

$$RIV = \{ \begin{matrix}{N}_{RBs} ( {L}_{RBs} - 1 ) + {RB}_{first} , if ( {L}_{RBs} - 1 ) \leq ⌊ {N}_{RBs} / 2 ⌋ \\ {N}_{RBs} ( {N}_{RBs} - {L}_{RBs} + 1 ) + ( {N}_{RBs} - 1 - {RB}_{first} ) , otherwise\end{matrix}$$

where N_{RBS} defines the total number of RBs within carrier or a selected/indicated BWP (bandwidth part).

In method 2, for example, if N_{RBS}=273 (for 100 MHz BW and 30 kHz subcarrier spacing (SCS)), and if the UL SB occupies 55 RBs starting from 105th RB, then the serving node would indicate RIV=14847 (which requires at least 14 bits, i.e., “11100111111111”).

In some implementations of method 2, for example, the serving node indicates UL SB firstRB and nrofRBs via a RIV, whereas it indicates only the nrofRBs of one or two GB SBs. In some other implementations, the serving node indicates GB SBs firstRB and nrofRBs via another RIVs.

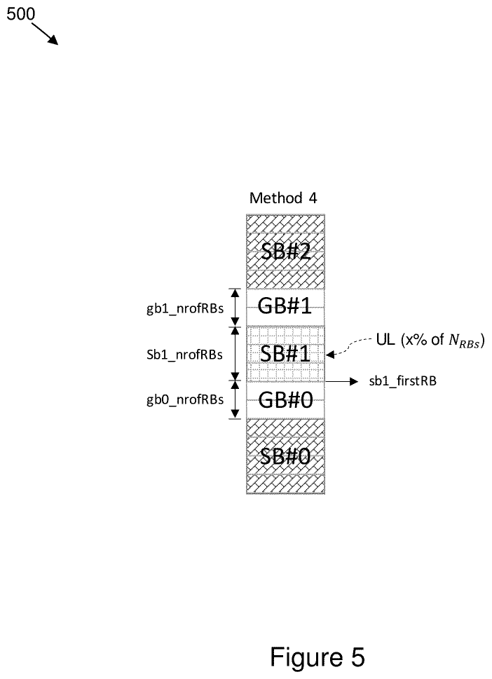

In certain embodiments, to further reduce an SB indication overhead, the first network node (e.g., a serving network node) indicates nrofRBs (e.g., L_{RBs}) of a SB as percentage of the SB RBs as compared to, for example, the total number of RBs N_{RBs}, as shown in FIG. 5. In some other examples, the percentage is calculated based on a predefined number of RBs.

For example, if N_{RBS}=273 (for 100 MHz BW and 30 kHz SCS), and if the UL SB occupies 55 RBs starting from 105th RB, then the UL SB occupies approximately 20% of N_{RBS} (as 55/273=0.2015) and the serving node would indicate RIV=5292 (which requires at least 13 bits, i.e., “1010010101100”) that is calculated as:

$$RIV = {N}_{R B s} ( {L}_{R B s} - 1 ) + R {B}_{f irst} = 273 ( 20 - 1 ) + 105 = 5292 .$$

The second network node (e.g., UE) may interpret the identified L_{RBs}=20 as a percentage value and then calculate the actual RBs length (e.g., nrofRBs) as:

$$nrofRBs = f ( \frac{{L}_{R B s}}{100} * {N}_{R B s} ) = f ( 0.2 * 273 ) = f ( 54.6 ) ,$$

where f(x) is a predefined function, e.g., f(x)=round (x), f(x)=ceil (x), or f(x)=floor (x).

In some implementations, the percentage of the indicated SB is quantized to be a multiple of 10, e.g.,

% of nrofRBs E {10%, 20%, 30%, . . . 90%},

wherein the indicated RIV is calculated after excluding “0”, i.e., “2 would imply 20%” and “3 would imply 30%”, and so on.

For example, if N_{RBS}=273 (for 100 MHz BW and 30 kHz SCS), and if the UL SB occupies 55 RBs starting from 105th RB, then the UL SB occupies approximately 20% of N_{RBs} (as 55/273=0.2015) and the serving node would indicate RIV=378 (which requires at least 9 bits, i.e., “101111010”) that is calculated as:

$$RIV = {N}_{R B s} ( {L}_{R B s} - 1 ) + R {B}_{f irst} = 273 ( 2 - 1 ) + 105 = 378 .$$

The second network node (e.g., UE) would interpret the identified L_{RBS}=2 as a percentage value after including “0”, and then calculate the actual RBs length (e.g., nrofRBs) as shown herein.

Other percentage quantization method may also be considered, e.g.,

% of nrofRBs E {05%, 15%, 25%, . . . 95%},

wherein the indicated RIV is calculated after excluding “5”, e.g., “0 would imply 5%”, “1 would imply 15%” and “2 would imply 25%”, and so on.

FIG. 5 illustrates an example 500 in which nrofRBs is indicated as percentage of the SB RBs as compared to the total number of RBs N_{RBs}.

In some examples, especially for GB SBs, the percentage of nrofRBs is below 10%. For example, if N_{RBS}=273 (for 100 MHz BW and 30 kHz SCS), the nrofRBs of a GB SB is, e.g., 5 RBs, which is approximately 2% of N_{RBS}=273. In this case, the second network node (e.g., UE) would interpret the identified L_{RBS}=2 as a percentage value without including any predefined value, and then calculate the actual RBs length (e.g., nrofRBs) as shown herein.

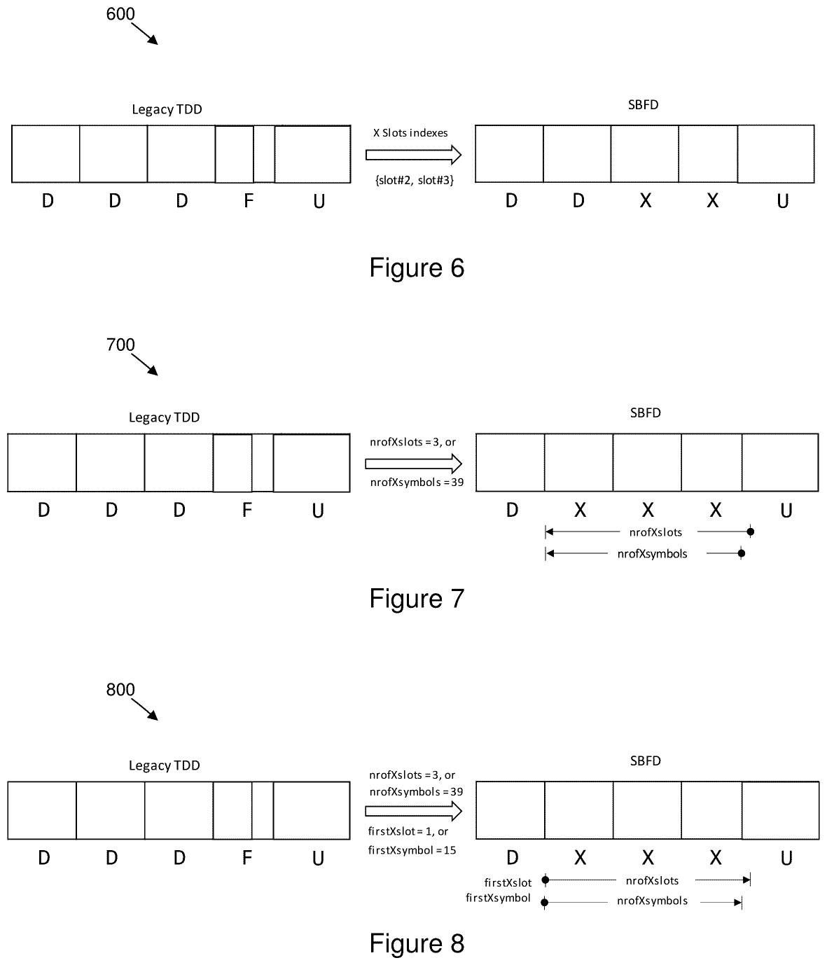

In various embodiments, there may be a time domain indication of an X slot (e.g., a SBFD slot). For a time domain indication as found in the first embodiment, the first network node may indicate X slots and/or symbols of a TDD UL-DL pattern to a second network node (e.g., a UE) using a combination of one or more of the methods described in relation to FIGS. 6, 7, and 8.

In a slot specific method, the serving network node indicates the X slots indexes explicitly. For example, assuming a DDDFU pattern with 5 slots indicated via tdd-UL-DL-ConfigurationCommon and tdd-UL-DL-ConfigurationDedicated, if configured, the serving network node may indicate slot #2 and slot #3 as X slots (e.g., as 00110) as illustrated in FIG. 6. Specifically, FIG. 6 illustrates an example 600 of a slot specific X slots indication.

In an X slot indication as a number of X slots and/or symbols the serving network node indicates the X slots and/or symbols via indicating a number of X slots and/or symbols (e.g., nrofXslots/nrofXsymbols), where the X slots and/or symbols are the nrofXslots and/or nrofXsymbols before the first UL slot and/or symbol that is configured by tdd-UL-DL-ConfigurationCommon and tdd-UL-DL-ConfigurationDedicated, if configured, as illustrated in FIG. 7. Specifically, FIG. 7 illustrates an example 700 of an X slots indication as a number of X slots or X symbols.

In an X slot indication as a starting X slot and/or symbol and a number of X slots and/or symbols, the serving network node indicates the X slots and/or symbols via indicating a starting slot and/or symbol index (e.g., firstXslot and/or firstXsymbol) and a number of X slots and/or symbols (e.g., nrofXslots/nrofXsymbols), such as by mapping them to an RIV number as illustrated in FIG. 8. Specifically, FIG. 8 illustrates an example 800 of an X slots and/or symbols indication as a number of X slots and/or symbols and a starting and/or first X slot and/or symbol.

With slot-based indication, if not explicitly indicated, the second network node (e.g., UE) assumes that all symbols within the indicated X slots are X symbols. Otherwise, the first network node explicitly indicates the X symbols of an indicated X slot using one of the following methods: 1) symbol specific where the X symbol indexes are indicated explicitly (e.g., symbol #0 and symbol #1); 2) as a number of X symbols (e.g., nrofXsymbols), where the X symbols are the first or the last nrofXsymbols of an indicated X slot; or 3) as a number of X symbols “nrofXsymbols” and a first X symbol “firstXsymbol” (e.g., mapped to an RIV number). In some examples, where the indicated slot is an F slot (e.g., it has DL, UL, and F symbols), the X symbols can be determined based on a preconfigured rule (e.g., “All D symbols”, “All F symbols”, or as “All D+F symbols”).

In some implementations, if time domain X slots configurations are not indicated, the UE applies the indicated frequency domain SB configurations to a preconfigured number of X slots, e.g., “All F” slots, “All D” slots, “All D+All F” slots, or to a predefined number of slots before the first UL slot that is configured via tdd-UL-DL-ConfigurationCommon and tdd-UL-DL-ConfigurationDedicated, if configured. In some examples, the “predefined number of slots” is pattern dependent.

In other implementations, if frequency domain SB configurations are not indicated, the UE applies a preconfigured SB configurations to the indicated X slots/symbols (e.g., Case 0 shown in FIG. 3), where the SB configurations are bandwidth dependent. In some other examples, the valid SB configurations of a given bandwidth are preconfigured (e.g., as shown in Table 1), wherein the table is extended to include the SB configurations for every frequency SB and cell and/or BWP bandwidth (or total number of RBs).

In a second embodiment, the first network node (e.g., a serving network node) indicates frequency domain SB configurations and time domain X slots and/or symbols configurations to a second network node (e.g., UE) by configuring a SBFD TDD UL-DL pattern that overlaps with one or more TDD UL-DL patterns that are configured via tdd-UL-DL-ConfigurationCommon and tdd-UL-DL-ConfigurationDedicated, if configured.

In some examples, the SBFD TDD UL-DL pattern is associated with one TDD UL-DL pattern (e.g., a one-to-one mapping), wherein the SBFD TDD UL-DL pattern has the same SCS and dl-UL-TransmissionPeriodicity as the associated TDD UL-DL pattern and it indicates one or more of: 1) an RIV value to indicate the SBFD TDD UL-DL pattern “first RB” and “number of RBs” (e.g., as percentage or non-percentage number); and/or 2) a number of RBs to be used as guard-band around the SBFD TDD UL-DL pattern (e.g., nrofGBRBs), wherein the GB RBs are only applied on RBs separating SBFD TDD UL-DL pattern UL RBs and associated TDD UL-DL pattern DL RBs.

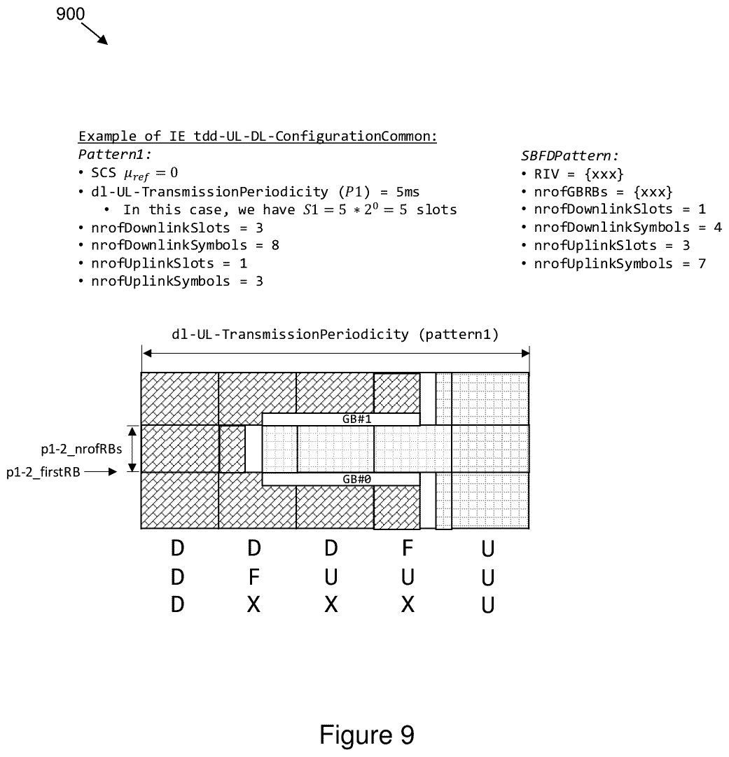

FIG. 9 illustrates an example 900 of a one-to-one mapping between a SBFD TDD UL-DL pattern and a TDD UL-DL pattern.

In some examples, the SBFD TDD UL-DL pattern is associated with two or more of TDD UL-DL patterns (e.g., a one-to-many mapping), wherein the SBFD TDD UL-DL pattern configurations include, in addition to the above, the indexes of the associated patterns. Moreover, the SBFD TDD UL-DL pattern is assumed to have the same SCS and dl-UL-TransmissionPeriodicity as the first TDD UL-DL pattern.

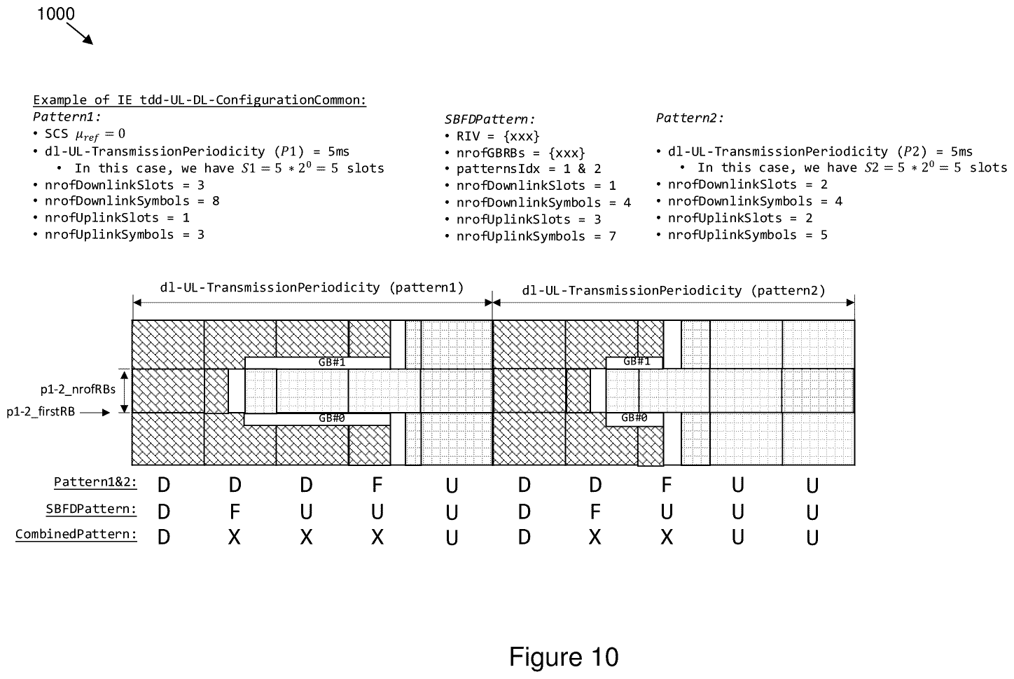

In certain examples, the indicated patterns have equal dl-UL-TransmissionPeriodicity and, therefore, an equal number of slots. In this case, the SBFD TDD UL-DL pattern is applied similarly for all patterns, as illustrated in FIG. 10. Specifically, FIG. 10 illustrates a first example 1000 of a one-to-many mapping between a SBFD UL-DL pattern and two TDD UL-DL patterns.

In some examples, the indicated patterns have unequal dl-UL-TransmissionPeriodicity and, therefore, unequal number of slots. In this case, the SBFD TDD UL-DL pattern is configured by the serving network node to align with the first TDD UL-DL pattern, and it is assumed to be adjusted to align with the other indicated TDD UL-DL patterns.

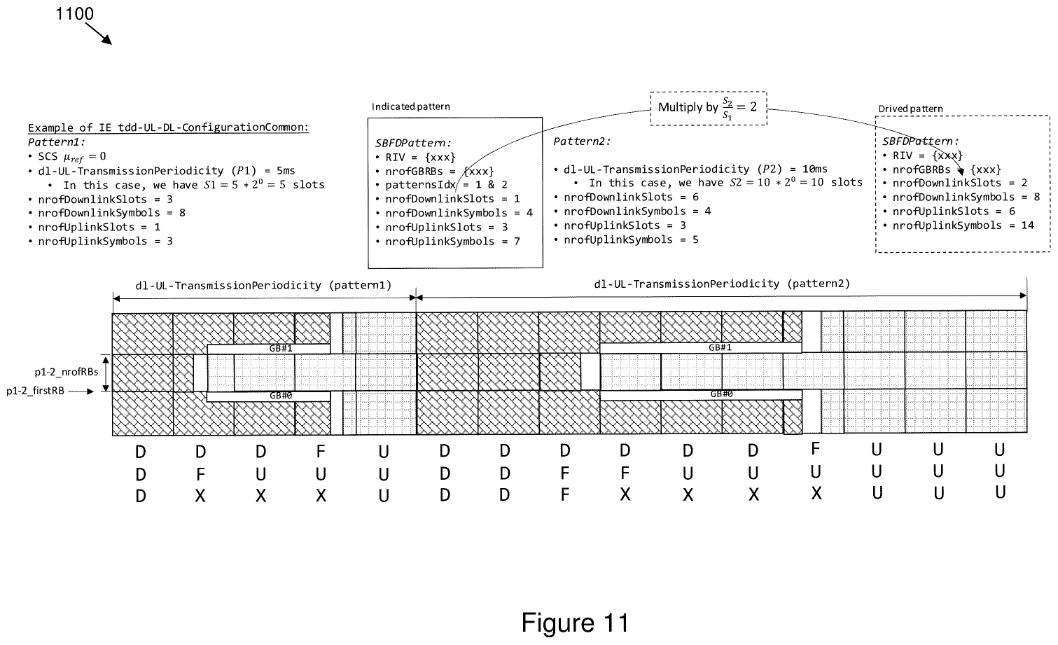

For example, as exemplified in FIG. 11, the SBFDPattern is aligned with pattern 1 (e.g., both have the same number of slots), but with different UL-DL slot configurations. However, pattern 2 has dl-UL-TransmissionPeriodicity equal to 10, which is double that of pattern 1 (i.e., S2=2*S1). The second network node (e.g., UE) would apply the SBFDPattern to overlap with pattern 1 as indicated, but it adjusts (or drives) the SBFDPattern that overlaps with pattern 2 using the indicated SBFDPattern parameters and

$$\frac{S 2}{S 1}$$

ratio. It should be noted that the UE assumes that the mapping is no valid if

$$\frac{Sx}{S 1} ,$$

x=2, 3, . . . , is not an integer value, which can be avoided by careful pattern configurations. Specifically, FIG. 11 illustrates a second example 1100 of a one-to-many mapping between a SBFD UL-DL pattern and two TDD UL-DL patterns.

The indications of SBFD time-frequency configurations may be cell-based, group-based, or UE-based carried by higher layer messages (e.g., SIB1), radio resource control (RRC), or downlink control information (DCI) messages. The configuration may be periodic, aperiodic, or semi-persistent and it may be in a new information element (IE) or carried in a legacy IE.

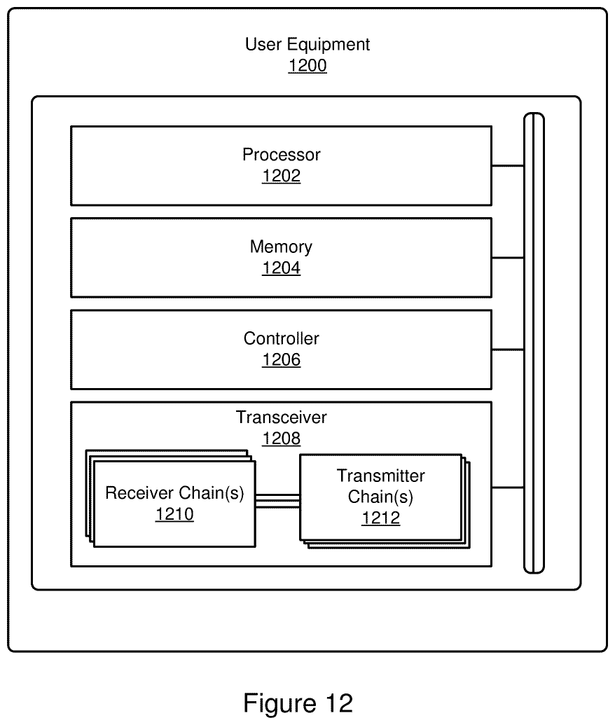

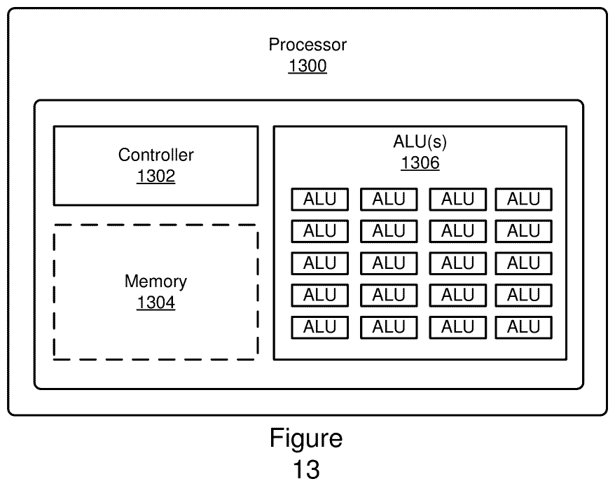

FIG. 12 illustrates an example of a UE 1200 in accordance with aspects of the present disclosure. The UE 1200 may include a processor 1202, a memory 1204, a controller 1206, and a transceiver 1208. The processor 1202, the memory 1204, the controller 1206, or the transceiver 1208, or various combinations thereof or various components thereof may be examples of means for performing various aspects of the present disclosure as described herein. These components may be coupled (e.g., operatively, communicatively, functionally, electronically, electrically) via one or more interfaces.

The processor 1202, the memory 1204, the controller 1206, or the transceiver 1208, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1202 may include an intelligent hardware device (e.g., a general-purpose processor, a DSP, a CPU, an ASIC, a field programmable gate array (FPGA), or any combination thereof). In some implementations, the processor 1202 may be configured to operate the memory 1204. In some other implementations, the memory 1204 may be integrated into the processor 1202. The processor 1202 may be configured to execute computer-readable instructions stored in the memory 1204 to cause the UE 1200 to perform various functions of the present disclosure.

The memory 1204 may include volatile or non-volatile memory. The memory 1204 may store computer-readable, computer-executable code including instructions when executed by the processor 1202 cause the UE 1200 to perform various functions described herein. The code may be stored in a non-transitory computer-readable medium such the memory 1204 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1202 and the memory 1204 coupled with the processor 1202 may be configured to cause the UE 1200 to perform one or more of the functions described herein (e.g., executing, by the processor 1202, instructions stored in the memory 1204). For example, the processor 1202 may support wireless communication at the UE 1200 in accordance with examples as disclosed herein.

The controller 1206 may manage input and output signals for the UE 1200. The controller 1206 may also manage peripherals not integrated into the UE 1200. In some implementations, the controller 1206 may utilize an operating system such as iOS®, ANDROID®, WINDOWS®, or other operating systems. In some implementations, the controller 1206 may be implemented as part of the processor 1202.

In some implementations, the UE 1200 may include at least one transceiver 1208. In some other implementations, the UE 1200 may have more than one transceiver 1208. The transceiver 1208 may represent a wireless transceiver. The transceiver 1208 may include one or more receiver chains 1210, one or more transmitter chains 1212, or a combination thereof.

A receiver chain 1210 may be configured to receive signals (e.g., control information, data, packets) over a wireless medium. For example, the receiver chain 1210 may include one or more antennas for receive the signal over the air or wireless medium. The receiver chain 1210 may include at least one amplifier (e.g., a low-noise amplifier (LNA)) configured to amplify the received signal. The receiver chain 1210 may include at least one demodulator configured to demodulate the receive signal and obtain the transmitted data by reversing the modulation technique applied during transmission of the signal. The receiver chain 1210 may include at least one decoder for decoding the processing the demodulated signal to receive the transmitted data.

A transmitter chain 1212 may be configured to generate and transmit signals (e.g., control information, data, packets). The transmitter chain 1212 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1212 may also include at least one power amplifier configured to amplify the modulated signal to an appropriate power level suitable for transmission over the wireless medium. The transmitter chain 1212 may also include one or more antennas for transmitting the amplified signal into the air or wireless medium.

FIG. 13 illustrates an example of a processor 1300 in accordance with aspects of the present disclosure. The processor 1300 may be an example of a processor configured to perform various operations in accordance with examples as described herein. The processor 1300 may include a controller 1302 configured to perform various operations in accordance with examples as described herein. The processor 1300 may optionally include at least one memory 1304, which may be, for example, an L1/L2/L3 cache. Additionally, or alternatively, the processor 1300 may optionally include one or more arithmetic-logic units (ALUs) 1306. One or more of these components may be in electronic communication or otherwise coupled (e.g., operatively, communicatively, functionally, electronically, electrically) via one or more interfaces (e.g., buses).

The processor 1300 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1300) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1302 may be configured to manage and coordinate various operations (e.g., signaling, receiving, obtaining, retrieving, transmitting, outputting, forwarding, storing, determining, identifying, accessing, writing, reading) of the processor 1300 to cause the processor 1300 to support various operations in accordance with examples as described herein. For example, the controller 1302 may operate as a control unit of the processor 1300, generating control signals that manage the operation of various components of the processor 1300. These control signals include enabling or disabling functional units, selecting data paths, initiating memory access, and coordinating timing of operations.

The controller 1302 may be configured to fetch (e.g., obtain, retrieve, receive) instructions from the memory 1304 and determine subsequent instruction(s) to be executed to cause the processor 1300 to support various operations in accordance with examples as described herein. The controller 1302 may be configured to track memory address of instructions associated with the memory 1304. The controller 1302 may be configured to decode instructions to determine the operation to be performed and the operands involved. For example, the controller 1302 may be configured to interpret the instruction and determine control signals to be output to other components of the processor 1300 to cause the processor 1300 to support various operations in accordance with examples as described herein. Additionally, or alternatively, the controller 1302 may be configured to manage flow of data within the processor 1300. The controller 1302 may be configured to control transfer of data between registers, arithmetic logic units (ALUs), and other functional units of the processor 1300.

The memory 1304 may include one or more caches (e.g., memory local to or included in the processor 1300 or other memory, such RAM, ROM, DRAM, SDRAM, SRAM, MRAM, flash memory, etc. In some implementations, the memory 1304 may reside within or on a processor chipset (e.g., local to the processor 1300). In some other implementations, the memory 1304 may reside external to the processor chipset (e.g., remote to the processor 1300).

The memory 1304 may store computer-readable, computer-executable code including instructions that, when executed by the processor 1300, cause the processor 1300 to perform various functions described herein. The code may be stored in a non-transitory computer-readable medium such as system memory or another type of memory. The controller 1302 and/or the processor 1300 may be configured to execute computer-readable instructions stored in the memory 1304 to cause the processor 1300 to perform various functions. For example, the processor 1300 and/or the controller 1302 may be coupled with or to the memory 1304, the processor 1300, the controller 1302, and the memory 1304 may be configured to perform various functions described herein. In some examples, the processor 1300 may include multiple processors and the memory 1304 may include multiple memories. One or more of the multiple processors may be coupled with one or more of the multiple memories, which may, individually or collectively, be configured to perform various functions herein.

The one or more ALUs 1306 may be configured to support various operations in accordance with examples as described herein. In some implementations, the one or more ALUs 1306 may reside within or on a processor chipset (e.g., the processor 1300). In some other implementations, the one or more ALUs 1306 may reside external to the processor chipset (e.g., the processor 1300). One or more ALUs 1306 may perform one or more computations such as addition, subtraction, multiplication, and division on data. For example, one or more ALUs 1306 may receive input operands and an operation code, which determines an operation to be executed. One or more ALUs 1306 be configured with a variety of logical and arithmetic circuits, including adders, subtractors, shifters, and logic gates, to process and manipulate the data according to the operation. Additionally, or alternatively, the one or more ALUs 1306 may support logical operations such as AND, OR, exclusive-OR (XOR), not-OR (NOR), and not-AND (NAND), enabling the one or more ALUs 1306 to handle conditional operations, comparisons, and bitwise operations.

The processor 1300 may support wireless communication in accordance with examples as disclosed herein. The processor 1300 may be configured to or operable to support a means for: receiving a configuration message for a subband time-frequency configuration, wherein the configuration message indicates frequency domain resources and time domain resources of at least one subband; and determining a transmission direction of the at least one subband, wherein the transmission direction comprises downlink, uplink, guard-band, or a combination thereof.

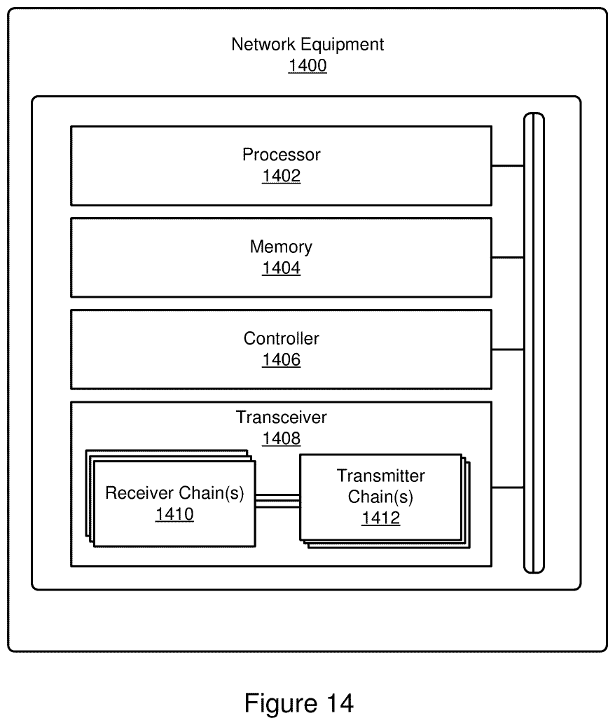

FIG. 14 illustrates an example of a NE 1400 in accordance with aspects of the present disclosure. The NE 1400 may include a processor 1402, a memory 1404, a controller 1406, and a transceiver 1408. The processor 1402, the memory 1404, the controller 1406, or the transceiver 1408, or various combinations thereof or various components thereof may be examples of means for performing various aspects of the present disclosure as described herein. These components may be coupled (e.g., operatively, communicatively, functionally, electronically, electrically) via one or more interfaces.

The processor 1402, the memory 1404, the controller 1406, or the transceiver 1408, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1402 may include an intelligent hardware device (e.g., a general-purpose processor, a DSP, a CPU, an ASIC, an FPGA, or any combination thereof). In some implementations, the processor 1402 may be configured to operate the memory 1404. In some other implementations, the memory 1404 may be integrated into the processor 1402. The processor 1402 may be configured to execute computer-readable instructions stored in the memory 1404 to cause the NE 1400 to perform various functions of the present disclosure.

The memory 1404 may include volatile or non-volatile memory. The memory 1404 may store computer-readable, computer-executable code including instructions when executed by the processor 1402 cause the NE 1400 to perform various functions described herein. The code may be stored in a non-transitory computer-readable medium such the memory 1404 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1402 and the memory 1404 coupled with the processor 1402 may be configured to cause the NE 1400 to perform one or more of the functions described herein (e.g., executing, by the processor 1402, instructions stored in the memory 1404). For example, the processor 1402 may support wireless communication at the NE 1400 in accordance with examples as disclosed herein.

The controller 1406 may manage input and output signals for the NE 1400. The controller 1406 may also manage peripherals not integrated into the NE 1400. In some implementations, the controller 1406 may utilize an operating system such as iOS®, ANDROID®, WINDOWS®, or other operating systems. In some implementations, the controller 1406 may be implemented as part of the processor 1402.

In some implementations, the NE 1400 may include at least one transceiver 1408. In some other implementations, the NE 1400 may have more than one transceiver 1408. The transceiver 1408 may represent a wireless transceiver. The transceiver 1408 may include one or more receiver chains 1410, one or more transmitter chains 1412, or a combination thereof.

A receiver chain 1410 may be configured to receive signals (e.g., control information, data, packets) over a wireless medium. For example, the receiver chain 1410 may include one or more antennas for receive the signal over the air or wireless medium. The receiver chain 1410 may include at least one amplifier (e.g., a low-noise amplifier (LNA)) configured to amplify the received signal. The receiver chain 1410 may include at least one demodulator configured to demodulate the receive signal and obtain the transmitted data by reversing the modulation technique applied during transmission of the signal. The receiver chain 1410 may include at least one decoder for decoding the processing the demodulated signal to receive the transmitted data.

A transmitter chain 1412 may be configured to generate and transmit signals (e.g., control information, data, packets). The transmitter chain 1412 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1412 may also include at least one power amplifier configured to amplify the modulated signal to an appropriate power level suitable for transmission over the wireless medium. The transmitter chain 1412 may also include one or more antennas for transmitting the amplified signal into the air or wireless medium.

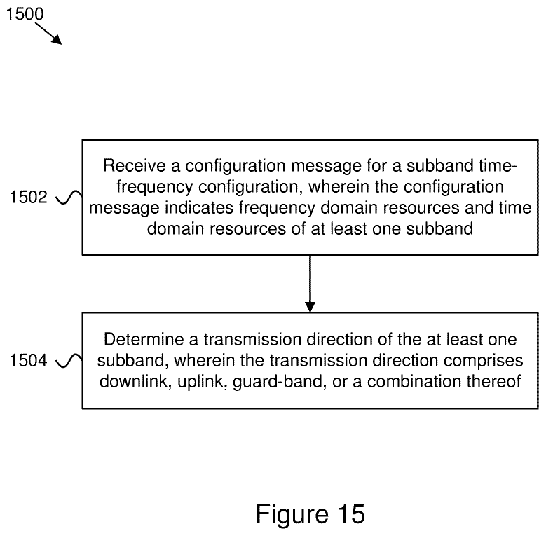

FIG. 15 illustrates a flowchart of a method 1500 in accordance with aspects of the present disclosure. The operations of the method 1500 may be implemented by a UE as described herein. In some implementations, a UE 1200 may execute a set of instructions to control the function elements of a processor to perform the described functions.

At 1502, the method may include receiving a configuration message for a subband time-frequency configuration, wherein the configuration message indicates frequency domain resources and time domain resources of at least one subband. The operations of 1502 may be performed in accordance with examples as described herein. In some implementations, aspects of the operations of 1502 may be performed by a UE as described with reference to FIG. 12.

At 1504, the method may include determining a transmission direction of the at least one subband, wherein the transmission direction comprises downlink, uplink, guard-band, or a combination thereof. The operations of 1504 may be performed in accordance with examples as described herein. In some implementations, aspects of the operations of 1504 may be performed by a UE as described with reference to FIG. 12.

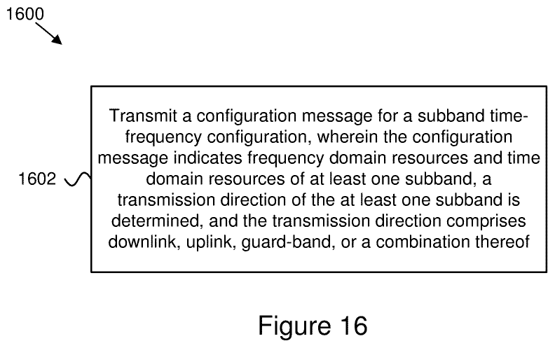

FIG. 16 illustrates a flowchart of a method 1600 in accordance with aspects of the present disclosure. The operations of the method 1600 may be implemented by a NE as described herein. In some implementations, a NE 1400 may execute a set of instructions to control the function elements of a processor to perform the described functions.

At 1602, the method may include transmitting a configuration message for a subband time-frequency configuration, wherein the configuration message indicates frequency domain resources and time domain resources of at least one subband, a transmission direction of the at least one subband is determined, and the transmission direction comprises downlink, uplink, guard-band, or a combination thereof. The operations of 1602 may be performed in accordance with examples as described herein. In some implementations, aspects of the operations of 1602 may be performed by a NE as described with reference to FIG. 14.

It should be noted that the methods described herein describe possible implementations, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
at least one memory; and
at least one processor coupled with the at least one memory and configured to cause the UE to:
receive a configuration message for a subband time-frequency configuration, wherein the configuration message indicates frequency domain resources and time domain resources of at least one subband; and
determine a transmission direction of the at least one subband, wherein the transmission direction comprises downlink, uplink, guard-band, or a combination thereof.

2. The UE of claim 1, wherein the configuration message indicates the frequency domain resources using a first resource block (RB), or a number of RBs, or both.

3. The UE of claim 2, wherein the number of RBs of the frequency domain resources is indicated as a percentage value of a reference number of RBs.

4. The UE of claim 3, wherein the reference number of RBs comprises a preconfigured number of RBs, a total number of RBs within a bandwidth part, a total number of RBs within a cell bandwidth, or a combination thereof.

5. The UE of claim 3, wherein part of the percentage value is implicitly determined.

6. The UE of claim 1, wherein the configuration message indicates the time domain resources using a slot index, a symbol index, a first slot, a first symbol, a number of slots, a number of symbols, or a combination thereof.

7. The UE of claim 6, wherein: the number of slots is indicated as a percentage value of a reference number of slots, the number of symbols is indicated as a percentage value of a reference number of symbols, or a combination thereof.

8. The UE of claim 1, wherein the time domain resources are implicitly indicated within the configuration message.

9. The UE of claim 1, wherein the frequency domain resources are implicitly indicated within the configuration message.

10. The UE of claim 1, wherein the configuration message comprises subband full duplex (SBFD) TDD uplink-downlink (UL-DL) patterns associated with corresponding TDD UL-DL patterns.

11. The UE of claim 10, wherein the corresponding TDD UL-DL patterns are provided by a tdd-UL-DL-ConfigurationCommon information element (IE), a tdd-UL-DL-ConfigurationDedicated IE, or a combination thereof.

12. The UE of claim 10, wherein an indicated SBFD TDD UL-DL pattern of the SBFD TDD UL-DL patterns is associated with one TDD UL-DL pattern of the TDD UL-DL patterns based on a one-to-one mapping rule.

13. The UE of claim 10, wherein an indicated SBFD TDD UL-DL pattern of the SBFD TDD UL-DL patterns is associated with at least two TDD UL-DL patterns of the TDD UL-DL patterns based on a one-to-many mapping rule.

14. The UE of claim 1, wherein the configuration message is provided by a radio resource control (RRC) configuration message.

15. The UE of claim 1, wherein the configuration message is cell-based and carried by a system information block 1 (SIB1) message.

16. The UE of claim 1, wherein the indicated subband has same SCS as the associated TDD UL-DL pattern.

17. The UE of claim 1, wherein the indicated subband has same time periodicity as the associated TDD UL-DL pattern.

18. A method performed by a user equipment (UE), the method comprising:
receiving a configuration message for a subband time-frequency configuration, wherein the configuration message indicates frequency domain resources and time domain resources of at least one subband; and
determining a transmission direction of the at least one subband, wherein the transmission direction comprises downlink, uplink, guard-band, or a combination thereof.

19. A base station, comprising:
at least one memory; and
at least one processor coupled with the at least one memory and configured to cause the base station to:
transmit a configuration message for a subband time-frequency configuration, wherein the configuration message indicates frequency domain resources and time domain resources of at least one subband, a transmission direction of the at least one subband is determined, and the transmission direction comprises downlink, uplink, guard-band, or a combination thereof.

20. A processor for wireless communication, comprising:
at least one controller coupled with at least one memory and configured to cause the processor to:
receive a configuration message for a subband time-frequency configuration, wherein the configuration message indicates frequency domain resources and time domain resources of at least one subband; and
determine a transmission direction of the at least one subband, wherein the transmission direction comprises downlink, uplink, guard-band, or a combination thereof.
